(19) United States
(12) Patent Application Publication
(10) Pub. No.: US 2024/0397996 A1
(43) Pub. Date: Dec. 5, 2024

(54) Laser-Etched Aerosol-Generating Article Wrapper, Aerosol-Generating Articles Comprising Such, and Their Method of Manufacture

(71) Applicant: JT INTERNATIONAL SA, Geneva (CH)

(72) Inventors: Hiroyoshi Ono, Tokyo (JP); Alexandru Bordei-Movileanu, Ploiesti (RO)

(73) Assignee: JT INTERNATIONAL SA, Geneva (CH)

(21) Appl. No.: 18/693,369

(22) PCT Filed: Sep. 14, 2022
(86) PCT No.: PCT/EP2022/075536

§ 371 Date: Mar. 19, 2024

(30) Foreign Application Priority Data
Sep. 20, 2021 (EP) 21197783.0

(51) Int. Cl. A24D 1/02; A24C 5/00; A24D 1/20; B23K 26/362; D21H 25/04

(52) U.S. Cl. CPC A24D 1/02; A24C 5/005; A24D 1/20; B23K 26/362; D21H 25/04

(57) ABSTRACT

An aerosol-generating article wrapper includes at least one layer of cellulosic material having a thickness extending from a first surface to a second surface opposite the first one of at least 35 micrometers and a tensile strength of at least 25 N/15 mm. The wrapper material includes at least part of an indicium etched in the at least one layer over a determined depth less than its thickness from one of the first or second surfaces. A method of manufacturing such wrapper includes a step of etching at least part of an indicium into the wrapper by evaporating wrapper material with a laser beam according to indicium vector lines over a determined depth less than the thickness of the cellulosic material layer. An aerosol-generating article includes such wrapper around at least a portion thereof, wherein the indicium in the wrapper is arranged at an outer facing surface of the article.

### CROSS-REFERENCE TO RELATED APPLICATIONS

The present application is a national phase entry under 35 U.S.C. § 371 of International Application No. PCT/EP2022/075536, filed Sep. 14, 2022, published in English, which claims priority to European Application No. 21197783.0 filed Sep. 20, 2021, the disclosures of which are incorporated herein by reference.

### FIELD OF THE INVENTION

The present invention relates to the field of aerosol-generating articles manufacturing, such as combustible or heat-not-burn (HNB) tobacco-containing articles. More specifically, the present invention relates to an aerosol-generating article wrapper comprising at least part of an indicium etched in the thickness of the wrapper material, methods of manufacturing of such aerosol-generating article wrapper and an aerosol-generating article comprising such wrapper.

### BACKGROUND OF THE INVENTION

Wrappers, in particular wrappers for wrapping an aerosol-generating material and/or mouthpiece and filter components of existing combustible or HNB aerosol-generating articles often comprise indicia formed by embossing, debossing, or printing, mostly for decorative and branding purposes. As practical, commonplace, and qualitative as they are, these existing indicia providing techniques are not free from downsides.

Material deformation techniques such as embossing require forming tools such as embossing rollers, specific for each indicum design to be formed in a wrapper material. Accordingly, each new indicium design requires a corresponding new roller, for each aerosol-generating article manufacturing machine or wrapper manufacturing machine. This implies a very costly design change process as embossing rollers cannot be retrofitted or converted to a new design.

Printing techniques are extremely popular and cost effective. They however imply use of various inks or varnishes which may from time-to-time transfer through the printed wrapper into the aerosol-generating material or to the aerosol generated during consumption of aerosol-generating articles comprising such wrappers during use, and by extension to users. Further, evolving regulatory constraints imposed on manufacturers by local authorities may also limit or forbid use of certain inks, varnishes or wrapper filler materials, which conversely may reduce the breadth of wrapper qualities or printing inks available for wrapper designers.

### SUMMARY OF THE INVENTION

It is therefore an objective of the invention to provide new aerosol-generating articles wrappers and methods of manufacture thereof that do not suffer from the above-mentioned drawbacks and offer greater flexibility for the provision of indicia onto said wrappers for aerosol-generating articles decorating and branding.

According to a first aspect of the invention, this objective is met by the provision of an aerosol-generating article wrapper, comprising at least one layer of cellulosic material having a thickness (t) extending from a first surface to a second surface opposite the first one of at least 35 micrometers and a tensile strength of at least 25 N/15 mm, wherein said wrapper comprises at least part of an indicium etched in said at least one layer over a determined depth (d) less than its thickness (t) from one of the first or second surface.

In the context of the present invention, tensile strength is measured using the method defined in ISO 1924-2:2008.

The inventors have advantageously found and ascertained that printed or material-deformation obtained indicia on wrappers as known from the prior art could be replaced in many cases by etching part of the wrapper material over a determined depth of its total thickness. Etched indicia were found to provide satisfying visual rendering, cost effective processing, and increased design change flexibility over prior art methods. Most importantly, it was also confirmed that the etching of an indicium into a wrapper material of a selected quality as herein defined did not induce critical alteration to the wrapper physical performance as required for the aerosol-generating products in which the wrapper is used. In particular, it was found that etched wrappers exhibit satisfying mechanical resistance during machine manufacturing of aerosol-generating articles, as well as in normal use by consumers.

In the context of the present invention, one shall interpret the term “etching” as a process or technique by which material is irreversibly removed in a controlled manner according to a specific design that can be defined according to vector lines by a chemical or physical process into a base material layer over a controlled depth, length and width into that base material layer.

According to the invention, a particularly well-suited etching technique to create etched indicia in aerosol-generating article wrappers is laser etching, by which cellulosic wrapper material is evaporated from a wrapper sheet by focusing a laser beam of determined wavelength and power moved over the wrapper sheet at selected linear speed to carve out lines from the sheet material.

In an embodiment, the determined depth (d) of the etched indicium is chosen to be at least a tenth, preferably a fifth, of the thickness (t) of the cellulosic material layer. Such depth was determined to be most appropriate to achieve visually perceivable indicium with a naked eye on a wrapper, even with minimal width of an etched line part of the indicium.

In an embodiment, the determined depth of the etched indicium is chosen at most ⅔, preferably at most half of the thickness (t) of the cellulosic material layer. Such maximum depth is chosen to ensure that the mechanical and physical properties of the etched wrapper meet manufacturing constraints of both wrapper and/or aerosol-generating article manufacturing.

In an embodiment, the at least one layer of cellulosic material has a basis weight of at least 34 g/m², preferably at least 40 g/m².

In an embodiment, the at least one layer of cellulosic material has a porosity of at most 15 CU (Coresta Units).

Such basis weight and porosity are particularly chosen for aerosol-generating articles' mouthpiece wrappers such as tipping wrappers, which are those most subject to bearing design features and indicia.

In an embodiment, the at least one layer of cellulosic material further comprises perforations extending from the first to the second surfaces of the at least one layer, wherein the perforations and the indicium are offset from each other by a non-zero distance in the at least one layer. Such perforations may for example be provided for ventilation purposes of filter sections of an aerosol-generating article, in particular in tipping wrappers.

In an embodiment, the perforations and the indicium are offset from each other by at least 1 mm, preferably at least 2 mm.

A second aspect of the invention relates to a method for manufacturing a wrapper material as previously described herein, comprising the steps of:
providing a laser marking device comprising a laser source having a nominal power of between about 20 W and 100 W, and
providing aerosol-generating article wrapper material, said wrapper material comprising at least one layer of cellulosic material having a thickness (t) extending from a first surface to a second surface opposite the first one of at least 35 micrometers and a tensile strength of at least 25 N/15 mm,
etching at least part of an indicium into the wrapper material by evaporating wrapper material with a laser beam according to indicium vector lines over a determined depth (d) less than the thickness (t) of said cellulosic material layer.

It was found by inventors that laser etching is the most suited etching technique for achieving etched indicia at individual wrapper level for aerosol-generating articles, with great flexibility of design and speed of etching and limited quality faults.

Laser etching allows for easy changing of the engraved design, as only the movement pattern of the laser beam on the wrapper material must be changed. Preferably, the engraver comprises a control system, which controls the movement of the laser beam over the wrapper material. Preferably, the control system transfers a digital image file, imported into the control system, into control signals, controlling the movement of the laser beam. In this way, any digital image file can be transferred into a laser etched indicium. To change the etched design only the digital image file has to be changed. Preferably, the control system comprises a data storage, in which digital image files can be stored. In this way, regularly used digital image files can be selected directly in the control system.

Also, the laser etching allows for design application without the addition of further substances into the wrapper material. This leads to an additive-free and easily adaptable engraving. As the process is additive free, there is also no sensory impact on the aerosol generated by the aerosol-generating article.

The chosen laser beam power is low enough so that the amount of energy subjected to the wrapper material per area unit is sufficiently low to prevent cutting, smoldering or burning of the wrapper material. On the other hand, the laser power is high enough to generate the desired etching or engraving effect.

In an embodiment of this method, the laser beam is directed from an emission point perpendicularly to one of the first or second surfaces of the wrapper material, a distance between said laser beam emission point the first or second surfaces of the aerosol-generating article wrapper material being at least 50 mm.

In an embodiment, the determined depth (d) of the etched indicium is at least a tenth, preferably a fifth of the thickness (t) of the cellulosic material layer.

In an embodiment, the determined depth of the etched indicium is at most ⅔, preferably at most half of the thickness (t) of the cellulosic material layer.

In an embodiment, the at least one layer of cellulosic material has a basis weight of at least 34 g/m², preferably at least 40 g/m².

In an embodiment, the at least one layer of cellulosic material has a porosity of at most 15 CU (Coresta Units).

In an embodiment, the laser source is a CO₂ laser source having a beam wavelength of 10.6 micrometers.

In another embodiment, the laser source is a fiber laser source having a beam wavelength of 1062 nanometers.

Both CO₂ and fiber laser sources as described above proved acceptable for providing etched indicia on aerosol-generating article wrappers according to the invention. Each source can in turn be arranged in various set-ups either at wrapper manufacturing level or aerosol-generating article manufacturing installations with great implementation flexibility.

In a first alternative of the inventive method, the aerosol-generating material wrapper is provided as a continuous web of wrapper material wound on a reel and the method further comprises the steps of:
unreeling said web from the reel and circulating it along a processing direction substantially perpendicular to a direction of the laser beam at a determined linear speed, and
sequentially etching the indicium or part thereof into the web of wrapper material at regular intervals along a length of the wrapper material web along the processing direction.

Under the above defined embodiment of the inventive method, which is fit for etching indicia at wrapper manufacturing level, the laser beam is preferably moved over the surface of the wrapper material at a linear speed of at least 5 m/min, preferably at least 15 m/min.

Still in this first alternative embodiment the method further comprises a step of cutting individual sheets of aerosol-generating wrapper material from the continuous web such that each individual sheet comprises at least one indicium etched in a surface thereof.

In a second alternative embodiment of the method of the invention, the at least one indicium or part of indicium is etched into the aerosol-generating wrapper once wrapped around a portion of an aerosol-generating article.

In this second alternative embodiment, the method allows for etching an indicium or multiple indicia over a group of aerosol-generating articles all at once, possibly with a single indicium etched across multiple articles such as in a collation of articles, thereby offering design opportunities rendering a single indicium impression upon opening for the consumer with each individual article bearing only part of the indicium and therefore being totally unique individually.

In this second alternative of the inventive method, the laser beam can advantageously be moved much faster than in the previous alternative as the etched indicium can be much larger than when provided for an individual wrapper. The laser beam can thus be moved over the surface of the wrapper material at a linear speed of at least 50 m/min, preferably at least 100 m/min.

In any one of the embodiments of the inventive methods as described above, it can further be of interest, for control and quality purposes, that margins of at least 1 mm, preferably at least 2 mm are arranged between an edge of the indicium and an edge of the aerosol-generating article wrapper material. This margin serves as an overlap area when the wrapper material is wrapped around an aerosol-generating article section. An adhesive may be applied in the overlap area to fix the wrapper material in place.

A further object of the present invention also advantageously relates to an aerosol-generating article comprising a wrapper material as previously described wrapped around at least a portion of said article, wherein the etched indicium in the wrapper is arranged at an outer facing surface of the aerosol-generating article. That way, aerosol-generating articles with etched design features at wrapper level can be provided with visually distinguishable indicia arranged into the articles constituting material, offering a very distinctive design at minimal cost for both manufacturers and consumers.

### BRIEF DESCRIPTION OF THE DRAWINGS

Further advantages, objectives and features of the present invention will be described, by way of example only, in the following description with reference to the appended figures. In the figures, like components in different embodiments can exhibit the same reference symbols.

The figures show:

FIG. 1 a schematic view of an aerosol-generating article wrapper etching process according to the invention;

FIG. 2 a schematic view of an aerosol-generating article comprising a laser etched tipping wrapper obtained by the method of FIG. 1;

FIG. 3 three different wrapper material continuous webs with laser etched indicia of three different designs;

FIG. 4 shows a picture of an individual laser-etched indicium representing a Camel® beast on an individual aerosol-generating article tipping wrapper sheet;

FIG. 5 shows a picture of etched indicia over tipping wrappers of collated aerosol-generating articles in a bundle.

### DETAILED DESCRIPTION OF THE INVENTION

For the avoidance of doubt, reference will be made throughout this specification to an aerosol-generating article wrapper material 1, which shall mean and be interpreted indifferently as a continuous web of wrapper material reeled in bobbin format as produced at a wrapper manufacturer or as individual wrapper material sheets, as cut from such a continuous web of wrapper material to be individually used to wrap part of an aerosol-generating article during the manufacture thereof, such as for example a filter plug wrapper or tipping wrapper in particular.

The present invention primarily relates to the provision of aerosol-generating article wrapper material 1 comprising design features, such as branding indicia, which are etched, and preferably laser-etched as discussed hereinafter. Etched wrappers bring several advantages over state-of-the-art embossing and printing techniques for the provision of simple, single color indicia on aerosol-generating article wrappers.

Among others, laser-etching indicia is fast, can be provided at various steps of the manufacturing process of either the wrapper material itself or at the final aerosol-generating article level, offering great flexibility of implementation and of indicium design shift change.

Further, laser-etching is an additive-free marking process, which enables aerosol-generating articles to create multiple indicium designs and combinations thereof at wrapper level without requiring multiple printing passes of the wrapper materials or multiple deformation rollers.

FIG. 1 shows a schematic view of a first laser-etching process for the manufacturing of a continuous web of etched aerosol-generating article wrapper material 1. A continuous web of virgin, i.e. etch-free, wrapper material 1, is fed from a first reel at an unwinding station A through a laser-etching station B in a feeding direction F. The wrapper material 1 may typically be an aerosol-generating aerosol article tipping wrapper material comprising, as shown in the enlarged section of FIG. 1, at least one layer of cellulosic material having a thickness (t) extending from a first surface 1a to a second surface 1b opposite the first one of at least 35 micrometers, and preferably at least 40 micrometers. Further, the wrapper material 1 must have a tensile strength of at least 25 N/15 mm, preferably at least 27 N/15 mm. This thickness t and tensile strength have been tested and ascertained by inventors as key wrapper qualities for qualitative and repeatable laser-etching of the wrapper material 1 without perforations nor alteration of the mechanical resistance of the wrapper for the later aerosol-generating article manufacturing.

Further preferably, where the wrapper material is to be used as a tipping wrapper of aerosol-generating articles, i.e. as a mouthpiece outer element, the at least one layer of cellulosic material has a basis weight of at least 34 g/m², preferably at least 40 g/m² and a porosity of at most 15 CU (Coresta Units). Other wrapper material basis weight and porosity may however be contemplated for uses as other wrapper material components of typical aerosol-generating articles, such as filter plug wrappers or tobacco substrate wrappers.

The continuous web of wrapper material 1 is dragged from the feeding station A and fed through the laser-etching station B by means of two pairs of rollers 2a, 2b and 3a, 3b arranged respectively ahead and behind an etching area E along the feeding direction F in the laser-etching station B. Both rollers 2a, 2b; 3a, 3b of a pair are in contact respectively with one of the two surfaces 1a, 1b of the wrapper material 1 and rotate with an identical angular speed w to ensure homogenous friction over the web of wrapper material 1 and constant linear speed thereof through the laser-etching station B.

The laser-etching station B further comprises a laser source 5, which generates a laser beam 5a having a nominal power of between about 20 W and 100 W at most. The laser beam 5a is directed from a laser head onto a first surface 1a of the wrapper material 1, for example via a mirror 6. The laser head and mirror 6 are arranged such that the distance D from either the laser head or mirror 6, depending which one of the laser head or mirror 6 directs the laser beam 5a onto the surface 1a of the wrapper material 1 is at least 50 mm to avoid excessive energy transfer from the laser beam 5a to the wrapper material 1 and possible cutting or perforation thereof.

The laser source 5 and mirror 6 are piloted by digital control means such as a computer (not shown) running a dedicated control program. The computer is advantageously also connected to a digital design library stored on either a local memory device such as a ROM (Read-only Memory) or RAM (Random-access Memory) or at a remote location, in particular on a cloud-based library accessible through the internet in a wired or wireless configuration. The digital design library advantageously stores multiple individual indicia designs digitally defined as vector lines stored in CAD file format for example or equivalent computer-readable format compatible for laser piloting, which are loaded by the control program of the computer to send corresponding driving commands to both laser source and mirror in order to etch corresponding one or several indicia onto the surface 1a of the wrapper material directly underneath the laser beam 5a. Such laser control techniques are well-known in the field of material laser processing and will not be developed further herein

The laser source 5 can be chosen to be either a CO₂ laser source, with a laser beam wavelength of 10.6 micrometers or a fiber laser source having a beam wavelength of 1062 nanometers. Both laser sources are well compatible with the needs of the etching process and particularly well-suited for evaporating cellulose-based materials as the wrapper material 1.

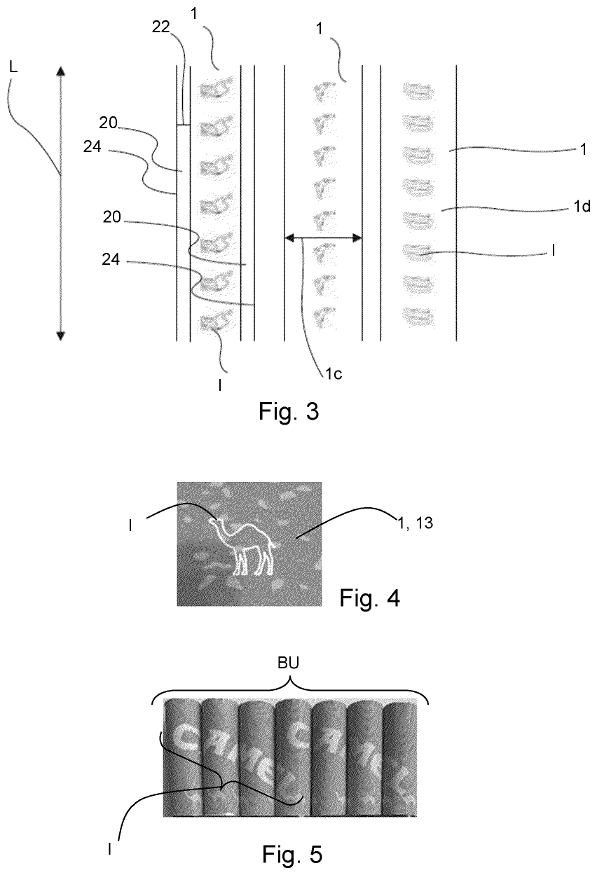

When the web of wrapper material 1 enters the etching area E in the laser-etching station B the laser beam 5a sequentially etches, i.e. partially and permanently removes cellulosic material from the wrapper, by evaporating said wrapper material along an etching path followed by the laser beam 5a driven by the control computer to form a dedicated indicium I according to indicium vector lines corresponding to at least one indicium design stored in the memory connected to said control computer. Etched indicia I are thus provided at regular intervals along the length of the wrapper material web 1 along the feeding direction F, as represented in FIG. 3. Of course, etching could also be provided continuously over a continuous length of the wrapper material as needed.

The etching is carried in a controlled manner over a determined depth (d) less than the thickness (t) of the cellulosic material layer thanks to constant control of the laser beam 5a power and distance to the surface 1a of the wrapper material as well as a constant feeding speed of the web under the traction of the pairs of rollers 2a, 2b; 3a, 3b. According to various tests carried out by the inventors, a depth (d) of an etched indicium may be at least a tenth, preferably a fifth of the thickness (t) of the cellulosic material layer and at most ⅔, preferably at most half of the thickness (t) of the cellulosic material layer.

Where a mirror 6 is used to direct the laser beam 5a onto the surface 1a of the wrapper material 1 the mirror 6 is movable along and about at least one, preferably two orthogonal directions X, Y. The moving directions X, Y preferably extend both perpendicularly to the feeding direction F, direction X defining with the feeding direction F a horizontal plane of the web of wrapper material 1 while direction Y extends perpendicularly to that feeding plane parallel to a vertical direction V. Moving of the laser beam 5a thanks to a movable mirror 6 allows for faster and more complex indicium design etching. More specifically in such movable laser beam 5a configuration the laser beam 5a may preferably be moved on the surface of the wrapper material 1 at a linear speed of at least 5 m/min, preferably at least 15 m/min.

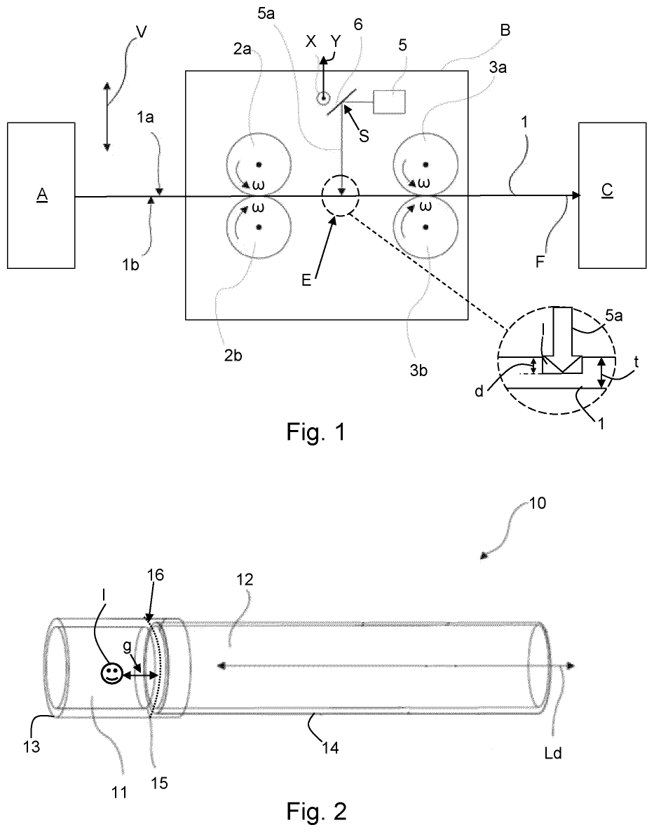

After passing through the etching area E and the second pair of rollers 3a, 3b the web of etched wrapping material 1 may be wound on a final reel at a final conditioning station C or directly fed further to an aerosol-generating article maker assembly where the wrapper material 1 is then cut in individual sheets of aerosol-generating wrapper material from the continuous web 1 such that each individual cut sheet comprises at least one indicium I etched in a surface thereof to provide one aerosol-generating article comprising such etched indicium I, as shown in FIG. 2.

FIG. 2 shows a schematic view of an embodiment of the aerosol-generating article 10 comprising a laser etched indicium I at an outer surface of a tipping wrapper 13. The aerosol-generating article 10 comprises, as per most common industry standards, a cylindrical shape. It consists of a filter rod 11 and an aerosol-generating material rod 12, both longitudinally attached to each other by the tipping wrapper 13 along a longitudinal direction Ld. The aerosol-generating material rod 12 is circumferentially wrapped by a typical cigarette wrapper 14. The filter rod 11 is commonly circumferentially wrapped by a first plug wrapper 15, and further wrapped on its outer surface by the tipping wrapper 13 bearing the indicium I on an outer surface for it to be visible to a consumer.

The laser etched indicium I denotes an etched area of the wrapper 13, which can be only a specific part of the outer surface of the wrapper 13, as shown in FIG. 2 or in the picture of a corresponding etched tipping wrapper 13 of FIG. 4. But it is also conceivable that the outer surface of the tipping wrapper 13 comprises more than one laser etched indicium I in multiple respective engraved areas, or that the whole outer surface of the tipping wrapper is etched of a continuous indicium I.

The tipping wrapper 13 further comprises in that example additional ventilation perforations 16, which extend fully through the wrapper material layer (i.e. from the first to the second surfaces 1a, 1b when the wrapper is considered flat as shown in FIG. 1). The ventilation perforations 16 and the etched indicium I are offset from each other by a non-zero distance g in the at least one layer of wrapper material 1.

The perforations 16 are typically produced by laser perforation during the aerosol-generating article manufacturing after the tipping wrapper material 13 has been wrapped about the filter rod 11 and tobacco rod 14 to attach it together. However, one same laser device cannot simultaneously or subsequently provide both the indicium I and perforations 16 because the required power and movements to etch and perforate are different. For that reason, it is preferable to carry out the indicium etching separately from the perforations, be it prior to aerosol-generating article manufacturing at continuous wrapper bobbin level as per the method of FIG. 1 or at a later stage such as during packaging process, as will be described further below.

FIG. 3 shows three different wrapper materials 1 as obtained from the method of FIG. 1, with laser etched indicia I featuring different designs arranged along a central etched area 1c along a length of the wrapper materials. The wrapper materials 1 also comprise etch-free side areas 1d in contrast to the etched areas 1c. The wrapper material 1 extends along a longitudinal direction L and only a part of the wrapper material 1 is shown.

In the leftmost wrapper material 1 shown in FIG. 3 margins 20 are shown. The margins 20 are arranged at the edges 24 of the wrapper material 1. The edges 24 are parallel to the longitudinal direction and are free of any etched indicium. Said margins 20 exhibit a width 22 as measured perpendicular to the longitudinal direction L, which is of at least 1 mm, preferably at least 2 mm between an edge 24 of the wrapper material 1 and a part of an indicium I farthest from the longitudinal axis of the wrapper material.

The margins 20 are preferably and advantageously provided such that they correspond to overlapping, gluing areas of the individual cut sheets of wrapper material such as tipping wrapper 13 in FIG. 2. These overlapping areas are preferably free from indicium to ensure better contact and adhesion of the wrapper about a corresponding section of an aerosol-generating article during manufacture and further use thereof, thereby preventing unwanted release of the wrapper from the article.

While the present invention is particularly suited for the provision of wrapper material comprising etched indicia on individual wrappers such as tipping wrappers to be arranged about a filter rod of individual aerosol-generating articles, as represented in FIG. 1-4 and described above it can further be extended to the provision of laser etched indicium at a broader level, and in particular over groups of aerosol-generating articles arranged in a bundle BU, as represented in FIG. 5.

In such embodiment, the at least one indicium I or part of an indicium is etched into an aerosol-generating article wrapper 1 not before it is cut to manufacture said article, i.e. offline, but once said wrapper 1 has been wrapped around a portion of an aerosol-generating article 10 and further bundled in a collation before packing in an outer cardboard or paper outer packaging as well known in the tobacco industry.

The etching process in such case is mostly identical to that described in relation to FIG. 1 except that collated bundles BU of aerosol-generating articles 10 are replacing a continuous web of wrapper material 1 and are subjected to a laser beam 5a to form an indicium I or multiple indicia I spanning over the whole group of articles in the bundles. Of course, the individual wrappers, e.g. tipping wrappers of each or some of the articles contained in a bundle may further comprise individual etched indicia provided according to the method of FIG. 1.

An advantage of etching indicia I over a group of articles BU is that it offers much greater etching area compared to individual wrappers and also much greater laser speed operation, with the laser beam 5a being moved on the surface of the wrapper material in the group of articles 10 in a processed bundle at a linear speed of at least 50 m/min, preferably at least 100 m/min.

The present invention thus provides new aerosol-generating article wrappers with etched decorative indicia obtainable through a variety of methods as described before, with great flexibility of implementation at various points of aerosol-generating article manufacturing and extreme flexibility of design, at competitive costs compared to existing wrapper decorating techniques.

1. An aerosol-generating article wrapper, comprising at least one layer of cellulosic material having a thickness extending from a first surface to a second surface opposite the first surface of at least 35 micrometers and a tensile strength of at least 25 N/15 mm, wherein said wrapper material comprises at least part of an indicium etched in said at least one layer over a determined depth less than the thickness from one of the first surface or the second surface.

2. The aerosol-generating article wrapper according to claim 1, wherein said determined depth of the etched indicium is at least a tenth of the thickness of the at least one layer.

3. The aerosol-generating article wrapper according to claim 1, wherein the determined depth of the etched indicium is at most ⅔ of the thickness of the at least one layer.

4. The aerosol-generating article wrapper according to claim 1, wherein the at least one layer of cellulosic material has a basis weight of at least 34 g/m².

5. The aerosol-generating article wrapper according to claim 1, wherein the at least one layer of cellulosic material has a porosity of at most 15 CU (Coresta Units).

6. The aerosol-generating article wrapper according to claim 1, wherein the at least one layer of cellulosic material further comprises perforations extending from the first surface to the second surface of the at least one layer, wherein the perforations and the indicium are offset from each other by a non-zero distance in the at least one layer of cellulosic material.

7. A method for manufacturing a wrapper material, comprising the steps of:
a. providing a laser marking device comprising a laser source having a nominal power of between 20 W and 100 W, and
b. providing an aerosol-generating article wrapper material, said wrapper material comprising at least one layer of cellulosic material having a thickness extending from a first surface to a second surface opposite the first surface of at least 35 micrometers and a tensile strength of at least 25 N/15 mm,
c. etching at least part of an indicium into the wrapper material by evaporating wrapper material with a laser beam according to indicium vector lines over a determined depth less than the thickness of said wrapper material.

8. The method according to claim 7, wherein the laser beam is directed from an emission point perpendicularly to one of the first or second surfaces of the wrapper material, a distance between said laser beam emission point and the one of the first or second surfaces of the aerosol-generating article wrapper material being at least 50 mm.

9. The method according to claim 7, wherein the determined depth of the etched indicium is at least a tenth of the thickness of the wrapper material.

10. The method according to claim 9, wherein the determined depth of the etched indicium is at most ⅔ of the thickness of the wrapper material.

11. The method according to claim 7, wherein the at least one layer of cellulosic material has a basis weight of at least 34 g/m².

12. The method according to claim 7, wherein the at least one layer of cellulosic material has a porosity of at most 15 CU (Coresta Units).

13. The method according to claim 7, wherein the aerosol-generating article material wrapper is provided as a continuous web of material wound on a reel and the method further comprises the steps of:
a. unreeling said web from the reel and circulating the web along a processing direction substantially perpendicular to a direction of the laser beam at a determined linear speed, and
b. sequentially etching an indicium or part thereof into the web of material at regular intervals along a length of the web along the processing direction.

14. The method according to claim 13, wherein the laser beam is moved over the surface of the wrapper material at a linear speed of at least 5 m/min.

15. The method according to claim 7, wherein the indicium or part of an indicium is etched into the wrapper material once wrapped around a portion of an aerosol-generating article.

16. The method according to claim 15, wherein the laser beam is moved over the surface of the wrapper material at a linear speed of at least 50 m/min.

17. An aerosol-generating article comprising a the wrapper material according to claim 1 around at least a portion thereof, wherein the etched indicium in the wrapper is arranged at an outer facing surface of the aerosol-generating article.

18. The aerosol-generating article wrapper according to claim 1, wherein said determined depth of the etched indicium is at least a fifth of the thickness of the at least one layer.

19. The aerosol-generating article wrapper according to claim 2, wherein the determined depth of the etched indicium is at most half of the thickness of the at least one layer.

20. The aerosol-generating article wrapper according to claim 1, wherein the at least one layer of cellulosic material has a basis weight of at least 40 g/m².
